(19) United States
(12) Patent Application Publication
(10) Pub. No.: US 2004/0249925 A1
(43) Pub. Date: Dec. 9, 2004

(54) Remotely controlling appliances using a wireless terminal

(76) Inventors: Seong-Joon Jeon, Yongin-city (KR); Ji-Hyun Park, Seoul (KR); Seong-Yun Ko, Seoul (KR); Myeon-Kee Youn, Incheon-city (KR)

Correspondence Address: Robert E. Bushnell, Suite 300, 1522 K Street, N.W., Washington, DC, 20005-1202, US

(21) Appl. No.: 10/856,862

(22) Filed: Jun. 1, 2004

(30) Foreign Application Priority Data
Jun. 4, 2003 (KR) 2003-36132

(51) Int. Cl. G06F 15/173

(52) U.S. Cl. 709/223

(57) ABSTRACT

A wireless terminal can be used in place of a remote control for controlling appliances located at a remote place. Unlike using infrared remote controls to control a plurality of appliances, one 802.11x wireless terminal can now control the appliances. Therefore, a user having a mobile phone, a smart phone, a PDA, a VoIP terminal or any other wireless terminal can easily control a plurality of appliances. In particular, a terminal such as a PDA with a special image display device can be provided with a user interface that has the exactly same configuration as a remote control. On the other hand, a general mobile phone with a display only has a special character indicating a remote control function.

### CLAIM OF PRIORITY

This U.S. non-provisional patent application claims priority under 35 U.S.C. § 119 of Korean Patent Application 2003-36132 filed on Jun. 4, 2003, the entire contents of which is hereby incorporated by reference.

### BACKGROUND OF INVENTION

1. Field of the Invention

The present invention relates, in general, to remotely controlling appliances using a wireless terminal, and more specifically, to a system and a method for remotely controlling appliances and a set-top-box, using a terminal with a built-in wireless function such as 802.11b/g/a for a WLAN (Wireless Local Area Network) or a wireless terminal such as a wireless VoIP (Voice Over Internet Protocol) phone.

2. Description of Related Art

In general, a remote control is a device with which a user can easily operate appliances such as TV, video tape recorder, audio equipment, cooking stove, or DVD player at a remote location. Because of its convenience, many people use the remote control for remote operation.

Most appliances come with a remote control for the convenience of users. To receive an infrared signal from a remote control, an electric appliance has a built-in infrared signal receiver on a front surface of the appliance. To prevent an operational error of the remote control, manufacturers use different frequencies for different appliances. This also means that a user must use an appropriate remote control for the appliance to be controlled.

As an attempt to solve the above problem, appliance manufacturers introduced an integrated remote control, capable of remote controlling diverse home electric appliances collectively. Thus, it is now possible to control a plurality of home appliances with one single remote control.

Moreover, recent advances in mobile communication techniques resulted in attracting a majority of people to use mobile phones. Keeping abreast of this trend, there is a need to develop a technique for remotely controlling home appliances using a mobile phone.

There are many pending applications associated with a method for remotely controlling home electric appliances using a mobile phone, including Korean Patent Application Nos. 20-2001-00204414 (entitled “Combined Mobile Telephone and Remote Control Terminal), 20-1998-0010921 (entitled “Mobile Phone with Remote Control Functionalities), 10-2001-0019036 (entitled “Mobile Telecommunication Terminal with Infrared Integration Functionalities), 10-1999-0039804 (entitled “Method for Implementing Wireless Home Communication Network using Bluetooth), and so on.

However, some of the aforementioned techniques require a repeater equipment, such as AP (Access Point), that controls home appliances according to a remote control signal from a wireless terminal. Other techniques simply introduce n wireless terminal with remote control functionalities in general, and do not necessarily discuss wireless communications between a wireless terminal and home electric appliances.

The Bluetooth technique, once regarded as a new, sensational technique when it was first introduced to the public back in 1998, has been forgotten by the press and the manufacturers even before it launched into the market in an early stage. Probably its lack of compatibility, problems associated with security and high-cost must have contributed to its early death in 2000 only after a two-year grace period.

Although some manufacturers tried to integrate Bluetooth with a LAN card, the technique for controlling data collision was not fully developed into a technique for commercial use. This is because when Bluetooth is used in a wireless LAN based network environment, noise occurs and the error rate in the wireless LAN is also increased, all resulting in low-speed communications.

The following patents also disclose features in common with the present invention but do not teach or suggest the inventive features specifically recited in the present application: U.S. Patent Application No. 2004/0010560, to Sandage et al., entitled METHOD AND APPARATUS TO TRANSMIT INFRARED SIGNALS GENERATED FROM A COMPUTER APPLICATION USING A REMOTE DEVICE, published on Jan. 15, 2004; U.S. Patent Application No. 2004/0010561 to Kim et al., entitled SYSTEM FOR REMOTELY CONTROLLING HOME APPLIANCES AND METHOD FOR OPERATING THE SAME, published on Jan. 15, 2004; U.S. Patent Application No. 2003/0018733 to Yoon et al., entitled SYSTEM AND METHOD FOR CONTROLLING HOME APPLIANCES, published on Jan. 23, 2003; U.S. Patent Application No. 2002/0077114 to Isham, entitled ERGONOMIC SYSTEM FOR CONTROL OF DEVICES THROUGH PORTABLE WIRELESS TERMINALS, published on Jun. 20, 2002; U.S. Patent Application No. 2002/0013819 to Lim et al., entitled INTERNET REMOTE CONTROLLER AND CONTROLLING METHOD FOR HOME APPLIANCES USING THE SAME, published on Jan. 31, 2002; U.S. Patent Application No. 2002/0045442 to Silen et al., entitled METHOD AND TELECOMMUNICATIONS NETWORK FOR CONTROLLING AN EXTERNAL DEVICE, published on Apr. 18, 2002; U.S. Patent Application No. 2002/0043557 to Mizoguchi et al., entitled REMOTE CONTROLLER, MOBILE PHONE, ELECTRONIC APPARATUS, AND METHOD OF CONTROLLING THE ELECTRICAL APPARATUS, published on Apr. 18, 2002; and U.S. Pat. No. 6,131,130 to Van Ryzin, entitled SYSTEM FOR CONVERGENCE OF A PERSONAL COMPUTER WITH WIRELESS AUDIO/VIDEO DEVICES WHEREIN THE AUDIO/VIDEO DEVICES ARE REMOTELY CONTROLLED BY A WIRELESS PERIPHERAL, published on Oct. 10, 2000.

### SUMMARY OF THE INVENTION

An object of the invention is to solve at least the above problems and/or disadvantages and to provide at least the advantages described hereinafter.

Accordingly, one object of the present invention is to solve the foregoing problems by providing a system and a method for remotely controlling a plurality of diverse appliances and a set-top-box, using a wireless terminal such as a terminal with a built-in wireless servicing function (e.g. 802.11b/g/a for a WLAN), a PDA, a smart phone or a wireless VoIP phone.

The foregoing and other objects and advantages are realized by providing a method for remote controlling a plurality of appliances using appliance remote control data transmitted from a wireless terminal connected to a network, the method including: receiving appliance remote control data transmitted from the wireless terminal over a network; determining if remote control mode data is included in the received remote control data; determining if data associated with the kind of appliance to be controlled is identical with data associated with the kind of appliance listed in a predetermined appliance table if the remote control data is included; and transmitting the appliance remote control data provided from the wireless terminal to a corresponding appliance over the network if the data associated with the kind of appliance to be controlled is identical with the data associated with the kind of appliance listed in the predetermined appliance table.

The appliance remote control data transmitted over a WLAN to the corresponding appliance includes an IP address of the appliance.

If the data associated with the kind of appliance to be controlled is not listed in the predetermined appliance table, an error message is transmitted to the wireless terminal over the network.

Another exemplary embodiment of the present invention provides a method for remotely controlling an appliance using appliance remote control data transmitted from a wireless terminal and from an AP (Access Point) connected to the wireless terminal via a WLAN, the method including: receiving appliance remote control data through the AP, the data being transmitted from the wireless terminal via the WLAN; converting a corresponding appliance's function control data from the received appliance remote control data into data recognizable by the corresponding appliance; and controlling a function of the corresponding appliance using the converted data.

The appliance remote control data received through the AP includes an IP address of the appliance, a remote control mode code, an appliance code, and an appliance's function control code, and the recognizable data transmitted to the corresponding appliance is IR data used by the corresponding appliance.

Converting the appliance's function control data to data recognizable by the corresponding appliance comprises: determining the kind of data by analyzing the received remote control mode code, and determining if the received data is appliance remote control data or general WLAN remote control data; and if the received data is the WLAN remote control data, converting the appliance's function control code to the IR data used by the corresponding appliance.

Another exemplary embodiment of the present invention provides a method for remotely controlling an appliance using appliance remote control data transmitted from a wireless terminal and from an AP (Access Point) connected to the wireless terminal via a WLAN, the method including: to remotely control an appliance, setting the wireless terminal into a remote control mode, selecting an appliance to be controlled out of a plurality of appliances and selecting a corresponding function of the appliance, and transmitting appliance remote control data to the AP via the WLAN; transmitting the appliance remote control data from the wireless terminal to the corresponding appliance via the WLAN if a data value associated with the kind of an appliance included in the appliance remote control data provided from the wireless terminal via the WLAN determined to be appliance data listed in a predetermined appliance table, the determination being made in the AP; converting the appliance remote control data provided from the AP to data recognizable by the corresponding appliance in the corresponding appliance, and controlling a function of the appliance using the converted data.

Another exemplary embodiment of the present invention provides an appliance remote control system, including: a wireless terminal adapted to transmit appliance remote control data via a WLAN, by setting a corresponding mode of the wireless terminal into a remote control mode for remotely controlling the appliance and selecting a kind of an appliance to control and a function of the appliance to be controlled from among a plurality of appliances; an AP (Access Point) adapted to transmit the appliance remote control data provided from the wirelss terminal to the corresponding appliance if data associated with a kind of appliance included in the appliance remote control data transmitted from the wireless terminal via the WLAN is identical with appliance data listed in a predetermined appliance table; and an appliance controller arranged within the appliance, and adapted to convert an appliance's function control data included in the appliance remote control data transmitted from the AP to data recognizable by the corresponding appliance, and to control a function of the corresponding appliance utilizing the converted data.

Preferably, a wireless terminal includes at least one of a terminal having an 802.11×wireless servicing capacity, a PDA, a smart phone, and a wireless VoIP phone, and the terminal includes: a user operable key input unit adapted to set a remote control mode for remotely controlling the appliance, and to select an appliance to control out of the plurality of appliances and to select a corresponding function of the appliance to control; a user interface (UI) adapted to display a remote control image for the selected appliance on a display device if the appliance to be controlled is selected by the user using the key input unit; and a transmitter adapted to transmit data to the AP via the WLAN, the data composed of a code for the remote control mode, a code for the selected appliance, and a control code of the corresponding appliance's function in a form of appliance remote control data, and the data being formatted specifically for the WLAN transmission.

The AP includes a receiver adapted to receive the appliance remote control data transmitted from the wireless terminal via the network; a comparison/decision unit adapted to determine if remote control mode data is included in the received remote control data, and if the remote control mode data exists, determining if data associated with the kind of appliance to be controlled is identical with data associated with the kind of appliance listed in a predetermined appliance table; and a transmitter adapted to transmit the appliance remote control data provided from the wireless terminal to the corresponding appliance via the WLAN if the data associated with the kind of appliance to be controlled is identical with the data associated with the kind of appliance listed in the predetermined appliance table. The transmission unit is adapted to transmit an error message to the wireless terminal via the network if the data associated with the kind of corresponding appliance does not exist in the appliance table.

In the exemplary embodiment, the appliance control device includes: a WLAN data receiver adapted to receive the appliance remote control data transmitted from the AP via the WLAN; a WLAN data analyzer adapted to analyze a remote control mode code value included in the appliance remote control data being received via the WLAN data receiver, so as to determine if the data is appliance remote control data or general WLAN data; a data converter adapted to convert the control code of the appliance's function into data recognizable by the corresponding appliance if the data being analyzed in the WLAN data analyzer is the WLAN remote control data; and a controller adapted to control a function of the corresponding appliance using the converted data from the data converter.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 diagrammatically illustrates a configuration of network connections to an appliance remote control system using a wireless terminal in accordance with an embodiment of the present invention;

FIG. 2 is a block diagram of a remote control data processor built in the appliances of the appliance remote control system using a wireless terminal in accordance with an embodiment of the present invention;

FIG. 3 is a flowchart describing control data transmission from a wireless terminal for controlling appliances in accordance with an embodiment of the present invention;

FIG. 4 is a diagram depicting a control data format transmitted from a wireless terminal for controlling appliances in accordance with an embodiment of the present invention;

FIG. 5 and FIG. 6 are exemplary diagrams of a user interface in a remote control image, being displayed on a display device of a wireless terminal;

FIG. 7 is a flowchart describing a procedure for processing in AP appliance control data transmitted from a wireless terminal and forwarding to a corresponding appliance;

FIG. 8 shows a control stack in an appliance for remote controlling appliances using a wireless terminal in accordance with an embodiment of the present invention;

FIG. 9 is a flowchart describing a processing of control data received from an appliance in accordance with an embodiment of the present invention; and

FIG. 10 is a detailed flowchart describing the processing of control data received from an appliance in FIG. 9.

### DETAILED DESCRIPTION

Before undertaking the detailed description of the invention of the invention below, it may be advantageous to give a brief explanation about a terminal with a built-in wireless servicing capacity such as 802.11/b/g/a for the WLAN.

As defined by an IEEE committee, the 802.11 standard is a collection of standards for WLAN architecture, and currently, there are four standards derived from this such as 802.11, 802.11a, 802.11b, and 802.11g. These four standards conform to CSMA/CA, an Ethernet protocol, to share a path.

Although the 802.11b standard provides a transmission speed of about 11 Mbps, the most recently approved 802.11 g standard provides a greater transmission speed, i.e. up to 54 Mbps, even for a relatively short distance. The 802.11 g standard, similar to 802.11b, works in a 2.4 GHz band, the two standards are compatible with each other.

The 802.11b standard, often called Wi-Fi, is compatible with IEEE 802.11 standards in general. Traditionally the modulation system defined in 802.11 is PSK, but the CCK modulation system has been recently chosen for the 802.11b standard in that the CCK modulation provides even greater data transmission speed and has less interferences caused by multi-path transfer.

The 802.11a standard is usually applied to a wireless ATM system, mainly to an access hub. The 802.11a standard operates in a 5 GHz-6 GHz wireless frequency bandwidth, and uses an OFDM modulation system so as to provide a maximum 54 Mbps data transmission speed. However, in reality, the data transmission speed is around 6 Mbps, 12 Mbps, or 24 Mbps.

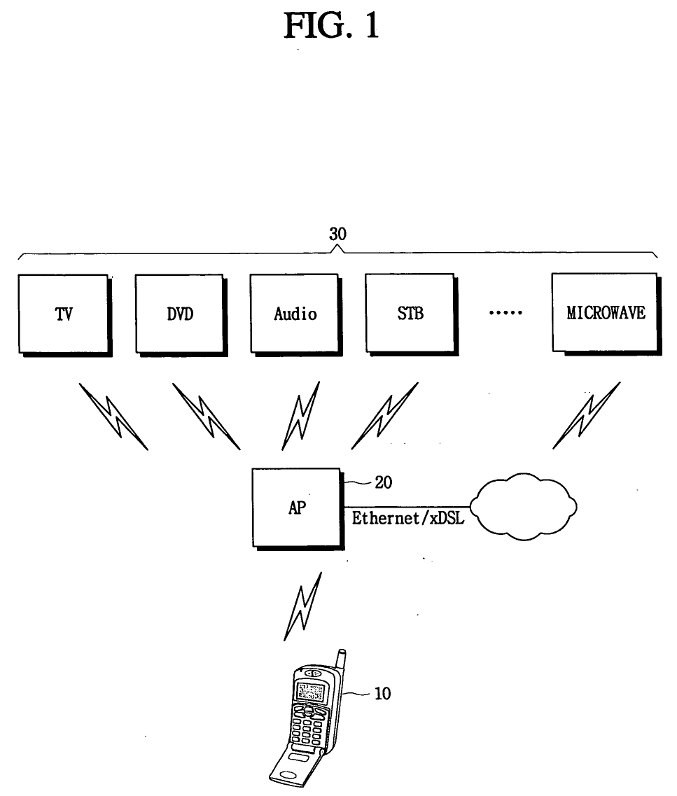

FIG. 1 diagrammatically illustrates a configuration of network connections to an appliance remote control system using a wireless terminal in accordance with an embodiment of the present invention.

As depicted in FIG. 1, the appliance remote control system using a wireless terminal includes a wireless terminal 10, an AP (Access Point) 20 and a plurality of appliances 30. The terminal 10 is selected from a group including a terminal with a built-in wireless servicing capacity such as an 802.11b/g/a for a WLAN, a PDA phone, a smart phone, and a wireless VoIP phone.

The terminal 10 in FIG. 1 is capable of remote controlling a plurality of appliances through the AP 20. To be more specific, the terminal 10 is first placed in a remote control mode, and once the remote control mode is set up, an appliance to be controlled or operated is selected. The terminal 10 then selects an actual control value of the selected appliance (e.g. in case of TV, the actual control value includes volume, changing TV channel, screen brightness and the like), and sends the actual control value to the AP 20. The data value transmitted from the terminal 10 to the AP 20 is composed of a remote control mode setup data value, a data value for a selected appliance and an actual control data value of the selected appliance. At this time, the transmitted data value includes header information. In short, the data format being transmitted from the terminal 10 to the AP 20 consists of a header+a remote control mode setup data value+a data value for a selected appliance+an actual control value of the selected appliance.

As such, if the appliance control data value is transmitted from the terminal 10 to the AP 20, the AP 20 deletes the header information from the data format being received, and analyzes the actual data value, in order to make sure the corresponding data is the remote control value needed to control an appliance.

If the corresponding data is the remote control data for controlling the appliance, a determination is made as to what kind of appliance is going to be controlled by the data.

After determining which appliance is going to be controlled, an IP address of the corresponding appliance and the remote control data transmitted from the terminal 10 are forwarded to the appliance.

The corresponding appliance 30 receives data from the AP 20, and determines if the received IP address is identical with its own IP address. If they are same, the received data (WRAN data) is converted to IR data, and the appliance corresponding to the converted data is controlled. The IR data is the same data the old IR remote control used to control the functions of appliances. After all, the follow-up procedure after conversion of data to the IR data corresponds to the follow-up procedure in the old IR remote control.

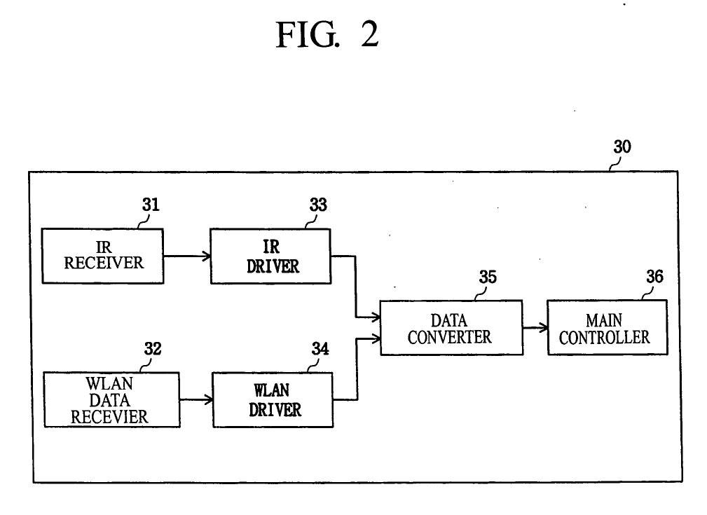

WLAN data processing in the appliance 30 is now explained with reference to FIG. 2.

FIG. 2 is a block diagram of a remote control data processor built in the appliances of the appliance remote control system using a wireless terminal in accordance with an embodiment of the present invention. As shown in the drawing, the system is configured with an IR receiver 31, a WLAN data receiver 32, an IR driver 33, a WLAN driver 34, a data converter 35, and a main controller 36.

The IR receiver 31 receives an IR signal transmitted through the old IR remote control, and provides the IR signal to the IR driver 33.

The WLAN data receiver 32 receives a WLAN remote control data transmitted from the AP 20, and provides the WLAN remote control data to the WLAN driver 34.

The IR driver 33 converts an IR signal provided from the IR receiver 31 to IR remote control data, and provides the converted IR remote control data to the main controller 36 through the data converter 35.

The WLAN driver 34 analyzes whether the WLAN data provided from the WLAN data receiver 32 is appliance remote control data or general WLAN data, and if the corresponding data is the appliance remote control data, the WLAN driver 34 provides the corresponding data to the data converter 35.

The data converter 35 converts the appliance remote control data provided from the WLAN driver 34, and transmits the converted IR remote control data to the main controller 36.

The main controller 36, using the appliance control data transmitted through the data converter 35, controls a function of the appliance associated with the corresponding data.

If a user wants to control an appliance using a terminal 10, the user places the terminal mode 10 in a remote control mode.

When the terminal is set in the remote control mode, the user selects which appliance he/she wants to control.

After selecting the kind of an appliance to be operated, the user selects a function to control.

Setting the remote control mode, selecting an appliance or selecting a function of the corresponding appliance can be accomplished simply by pressing proper keys (or buttons) mounted on the terminal. The user can use one key to select an appliance to be controlled based on the toggle method, or use a separate menu key, wherein a list of modes, appliances and control functions per appliance is displayed in a tree shape on a display device, so that the user can easily select what he/she wants.

When the user makes decisions on each, e.g. setting the remote control mode, and selecting an appliance and control function thereof, a code value (data value) for each is generated, and each of the code values is wirelessly transmitted to the AP 20. When each code value is transmitted, the terminal 10 adds a header value thereto. That is, the data for transmission is formatted, which includes header, remote control data, appliance data, and control function data.

The AP 20 receives the WLAN data value transmitted from the terminal 10, and analyzes the received data value by first determining if a remote control code value is included in the received data.

If the remote control value exists, the AP acknowledges that the corresponding data is the remote control data for controlling an appliance, and then determines which appliance is going to be controlled. To do so, the AP 20 searches an appliance table to see if the corresponding appliance is listed therein. The appliance table is listed with code values for different kinds of appliances and an IP address of a corresponding appliance.

If the corresponding appliance is found in the appliance table, the AP searches for the appliance's IP address, and forwards the IP address and the received remote control data value to the corresponding appliance.

Thusly transmitted remote control data from the AP 20 is received by the WLAN data receiver 32 in FIG. 2, and eventually forwarded to the WLAN driver 34.

The WLAN driver 34 analyzes whether the WLAN data provided from the WLAN data receiver 32 is appliance remote control data or general WLAN data, and if the corresponding data is appliance remote control data, the WLAN driver 34 provides the corresponding data to the data converter 35.

The data converter 35 converts the appliance remote control data provided from the WLAN driver 34, and transmits the converted IR remote control data to the main controller 36.

The main controller 36, using the appliance control data transmitted through the data converter 35, controls a function of the appliance associated with the corresponding to the data.

A method for remote controlling appliances using a wireless terminal, which corresponds to the appliance remote control device discussed above, will be discussed below, referring to the drawings.

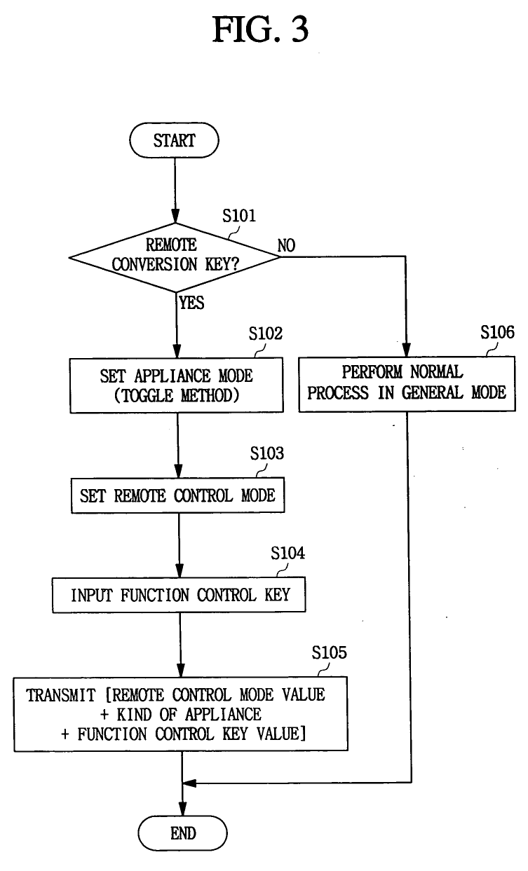

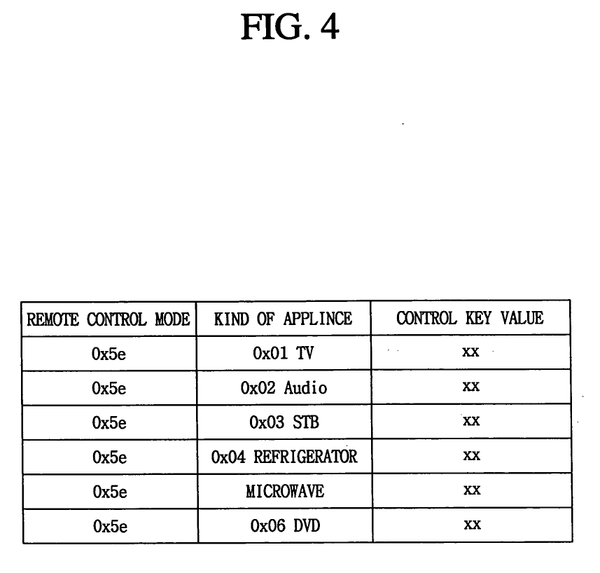

FIG. 3 is a flowchart describing control data transmission from a wireless terminal for controlling appliances in accordance with an embodiment of the present invention, and FIG. 4 is a diagram depicting a control data format transmitted from a wireless terminal for controlling appliances in accordance with an embodiment of the present invention.

As illustrated in FIG. 3, at first, the user determines if a remote control mode conversion key on the terminal 10 has been input (S101).

If the remote control mode conversion key has been input, the user selects an appliance to be controlled (S102). But if the remote control conversion key has been not selected, the terminal operates in a general mode (S106).

Therefore, the terminal 10 turns to the remote control mode (S103) only after the remote control mode key and the appliance to be controlled are selected.

Once the terminal is in the remote control mode, the user selects a control function of the corresponding appliance to be controlled (S104).

Then the AP 20 is provided with the data associated with the selected remote control mode value, the kind of an appliance to be controlled, and a control value for the selected appliance (S105). Generally, the header value is added to the data. The data format that is transmitted to the AP from the wireless terminal 10 typically looks like FIG. 4.

In other words, when the user presses a key on a general wireless terminal, say to make a call, the corresponding key value (or key values having been input) is not transmitted until the user presses the SEND key. However, when the wireless terminal is used as a remote control, the user sends a key value every time he/she presses a key. To do so, the terminal mode is converted to the remote control mode.

A particular key is used as remote control conversion mode key (e.g. use ‘CANCEL’ key for VoIP phone or mobile phone). For instance, similar to the toggle method, if the user keeps pressing the CANCEL key, he/she can select an appliance to be controlled, such as TV, Audio, STB, DVD, refrigerator, microwave etc., and if the user presses the particular key, the remote control mode is set up.

Moreover, if the user presses the remote control conversion key again, the remote control mode is released and the general mode returns, just like the toggle method.

When the user selects the appliance control function key while the wireless phone is in remote control mode, the AP 20 is provided with data, namely (a header value+a remote control mode value+a kind of an appliance+a key value being input).

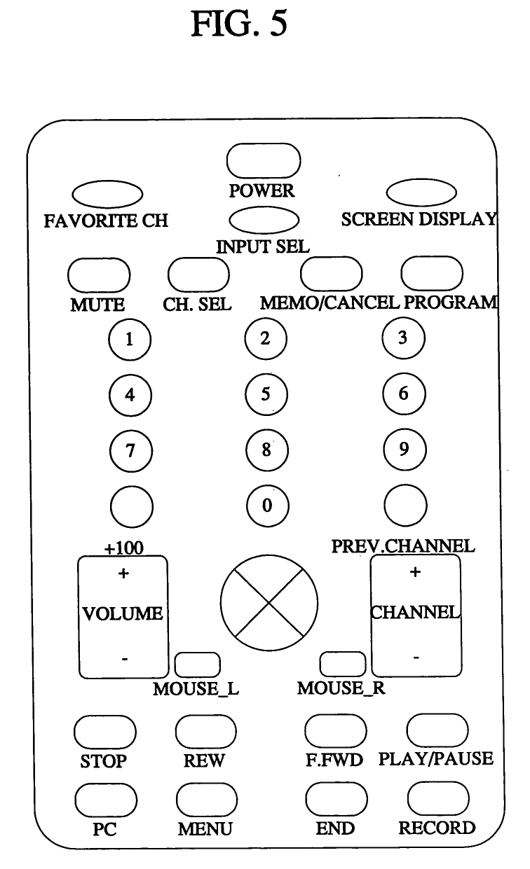

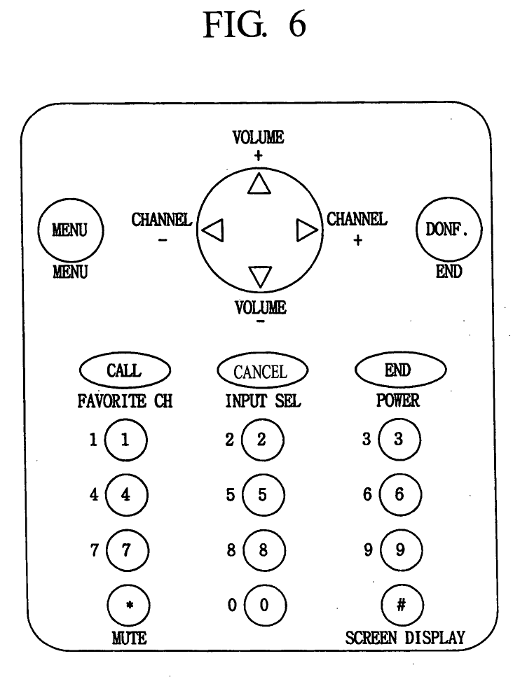

According to other exemplary embodiments for setting the remote control mode, the user can press arbitrary keys arranged on the terminal to set the remote control mode, select an appliance, and select a function of the corresponding appliance, or the user can use one single key to select an appliance (the toggle method being applied here again), or the aforementioned selection items can be arranged in a tree-shaped list and displayed on a display device, whereby the user can select more conveniently what he/she wants. Also, after the user sets the remote control mode and selects an appliance to be controlled, a user interface having a remote control image, similar to the ones in FIG. 5 and FIG. 6, can be displayed on the screen, so the user can select a wanted function on the user interface screen. FIG. 5 and FIG. 6 are exemplary diagrams of a user interface in a remote control image, being displayed on a display device (i.e. a screen) of a wireless terminal.

In particular, FIG. 5 shows a UI (User Interface) that is displayed when the user uses a terminal having an image display device, e.g. PDA. What the user only has to do in this case is to select an appropriate key for controlling the appliance from among other keys displayed on the remote control imaged UI.

FIG. 6, on the other hand, shows a remote control imaged UI that is displayed when the user uses a general mobile phone without any particular image display device. In this case, the user converts the terminal mode to the remote control mode, and selects a wanted function by pressing one of the normally used keys. As shown in FIG. 5 and FIG. 6, it will be more convenient to users if each key is provided with a special description, such as subtitles associated with the key.

The remote control data transmitted to the AP 20 from the wireless terminal 10 is processed in the AP 20.

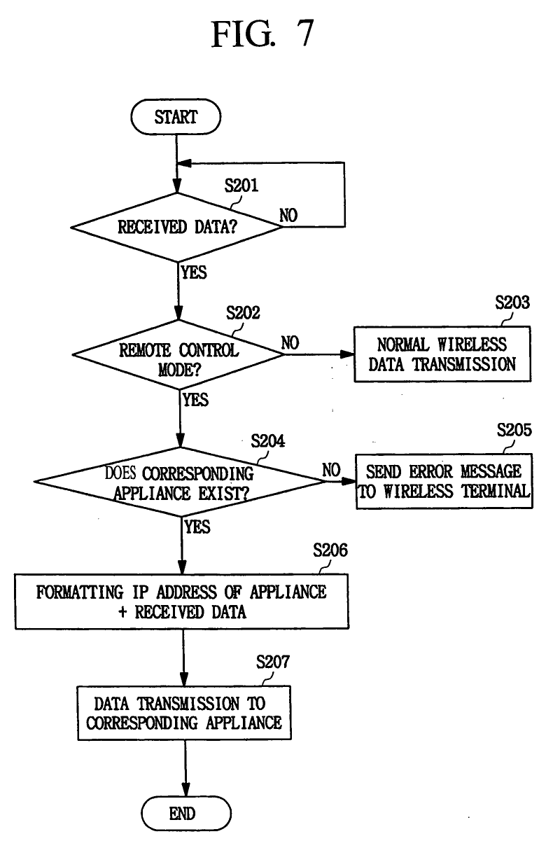

FIG. 7 is a flowchart describing a procedure for processing in AP appliance control data transmitted from the wireless terminal 10 and then forwarding it to a corresponding appliance 30.

As illustrated in FIG. 7, the AP 20 determines if the WLAN data is provided from the wireless terminal 10 (S201).

The AP 20 then determines if the remote control mode data is included in the received data (S202).

If it turns out that general WLAN data, not remote control mode data, is included in the received data, the normal wireless data transmission process is performed (S203). On the contrary, if remote control mode data exists in the received data, the AP 20 determines if the data associated with the kind of appliance is for an appliance listed in the appliance table.

If the data associated with the kind of corresponding appliance is found in the appliance table, it means the appliance exists in the area managed by the AP 20. In this case, the AP 20 creates a data format including the IP address of the corresponding appliance and the appliance remote control data received from the terminal 10 (S206), and forwards the formatted data to the corresponding appliance (S207).

In step 204, however, if the data associated with the kind of corresponding appliance is not listed on the appliance table, it is concluded that the appliance does not exist in the area managed by the AP 20. In such a case, the AP 20 forwards an error message to the terminal 10 (S205).

In summary, the AP determines if the remote control mode (e.g. 0x5e) is included in the received data upon receiving the WLAN data from the terminal 10.

If the received data is other general data instead of the remote control mode data, the normal wireless data processing is performed. However, if remote control mode data is received, the AP recognizes it as the remote control mode, and searches the appliance table to determine if the appliance is listed.

If the corresponding appliance is not listed in the appliance table, the AP forwards an error message to the terminal, indicating that the corresponding appliance does not exist in the appliance table.

However, if the corresponding appliance is found in the table, this means that the corresponding appliance 30 is included in a wireless area managed by the AP 20. In this case, the AP forwards a data format (IP address of the corresponding appliance+received data) to the appliance 30.

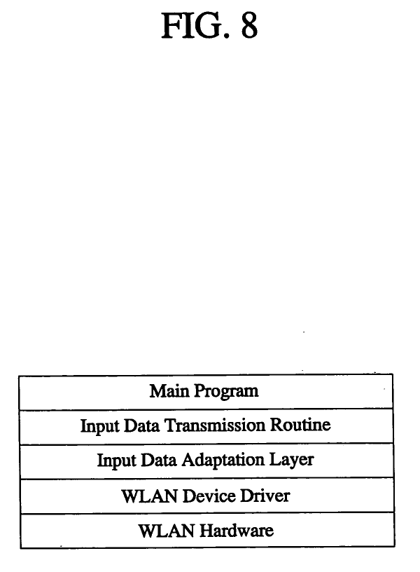

Therefore, when the AP 20 sends the remote control data for controlling an appliance to the corresponding appliance 30, the appliance 30 is operated according to the received remote control data. Before discussing a procedure to be undertaken in an appliance for controlling a function conforming to the received remote control data from the AP 20, the appliance control stack architecture will be described with reference to FIG. 8.

FIG. 8 shows a control stack in an appliance for remote controlling appliances using a wireless terminal in accordance with an embodiment of the present invention,

As shown in FIG. 8, the appliance control stack architecture includes an WLAN hardware, a WLAN device driver, an input data adaptation layer, an input data transmission routing and a main program.

A determination is made as to whether the data received by the WLAN hardware (WLAN receiver) is data that needs to be forwarded to the main program via the WLAN device driver, or is general WLAN communication data.

If the received data must be forwarded to the main program, it is first sent to the input data adaptation layer. On the other hand, if the received data is general communication data, it follows a predetermined processing routine.

In the input data adaptation layer, a signal transmitted from the WLAN device driver is converted to a remote control input signal according to a given table where key values of a remote control and a wireless terminal are mutually intermapped, and then again transmitted following the input data transmission routine. The procedure is conducted just the same as operating the main program through an IR signal of the remote control. As a result, the main program conducts an operation defined by the input signal.

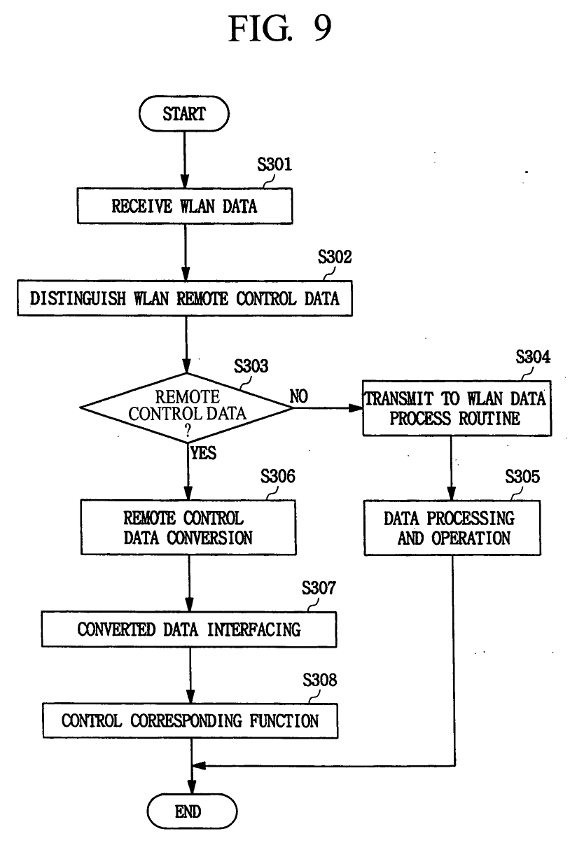

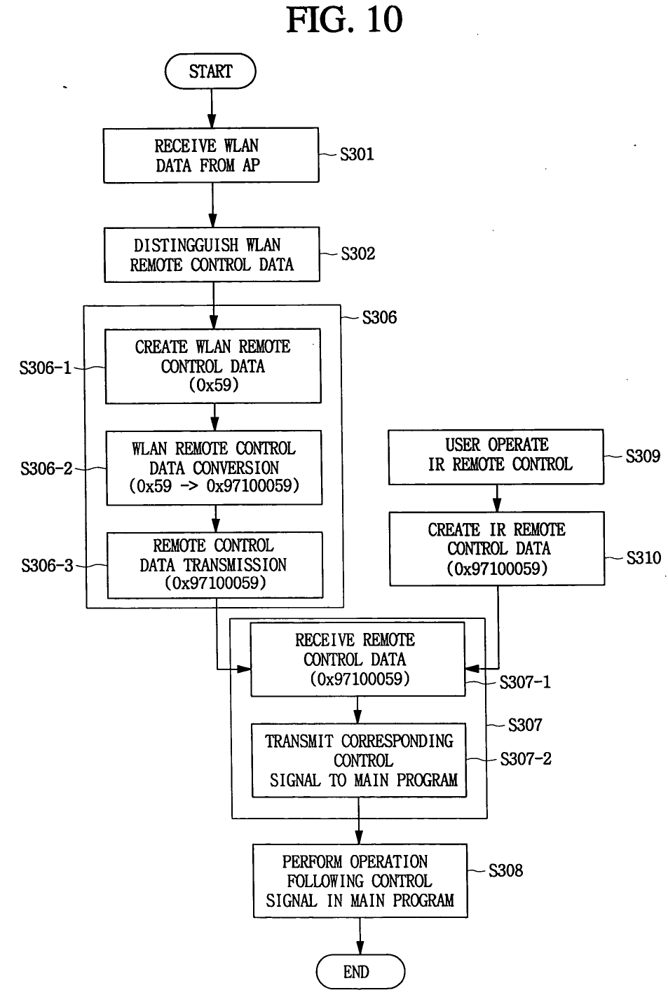

Given an appliance with the above stack architecture, a method for controlling the appliance using data from the AP 20 is now explained, referring to FIG. 9 and FIG. 10.

FIG. 9 is a flowchart describing a processing of control data received from an appliance in accordance with an embodiment of the present invention; and FIG. 10 is a detailed flowchart describing the processing of control data received from an appliance in FIG. 9.

As shown in FIG. 9, the WLAN hardware (WLAN receiver) in FIG. 8 receives WLAN data from the AP 20, and provides the WLAN data to the WLAN device driver (S301).

The WLAN device driver analyzes a remote control mode code in the received WLAN data, and distinguishes the kind of data (S302). That is, the WLAN device driver determines if the corresponding data is appliance remote control data or general WLAN data (S303).

If the received data is general wireless data (WLAN data), and not remote control data, the corresponding data goes through a general WLAN data processing routine (S304) to be processed (S305).

However, if the received data is determined to be remote control data in step 303, in the input data adaptation layer, a corresponding appliance's function control code (e.g. the control key value in FIG. 4) of the received remote control data is converted to an IR code value that is typically used in general appliances (S306).

The converted IR code value is interfaced with the main program through the input data transmission routine (S307).

Hence, based on the interfaced IR code value through the input data transmission routine, the main program is able to control the corresponding appliance (S308).

FIG. 9 is a flowchart describing each procedure associated with data transmission under a WLAN signal, and processing data provided to the corresponding appliance through the AP 20. Here, if WLAN data is produced by the WLAN device driver, the WLAN data is read to determine if it is remote control data.

If the WLAN data is not remote control data, the data undergoes the general wireless data process. However, if the WLAN data is remote control data (e.g. ox5e), a key conversion process for converting a key value is produced in the input data adaptation layer.

The input data transmission routine sends the data to the main program, and based on this data, the specific functions of appliances, such as volume, brightness, channel change, are controlled.

The method for remote controlling appliances using a wireless terminal is elaborated below.

As depicted in FIG. 10, WLAN data transmitted from the AP 20 is sent to the WLAN hardware (WLAN receiver) in FIG. 8, and then to the WLAN device driver (S301).

The WLAN device driver analyzes the code of the remote control mode included in the WLAN data to distinguish the kind of data, and determines if the corresponding data is an appliance's remote control data or general WLAN data (S302).

If the received data is the WLAN remote control data, the input data adaptation layer receives appliance control key values (e.g. 0x59) from the WLAN device driver (S306-1).

The input data adaptation layer converts the appliance control key values to appropriate IR data for the corresponding appliances (i.e. 0x59→0X97100059) (S306-2), and sends the converted appliance control IR data to the input data transmission routine (S306-3).

The input data transmission routine receives the appliance control IR data from the input data adaptation layer (S307-1), and sends it to the main program (S307-2).

Then, the main program is in charge of controlling a corresponding appliance based on the appliance control IR data transmitted from the input data transmission routine (S308).

On the other hand, if the user sends an appliance control IR signal using an IR remote control of the corresponding appliance, not using a wireless terminal (S309), an IR signal (e.g. 0x97100059) arrives at the IR receiver located within the appliance as shown in FIG. 2 (S310).

The received IR signal is provided to the input data transmission routine and the main program, and used for controlling the appliance.

Thus, the input data adaptation layer waits for the remote control data from the WLAN device driver to be input. Once the remote control data is input, the input data adaptation layer converts the data so as to be readable by the main program, and transmits it to the input data transmission routine.

Each appliance is originally supposed to operate only when it receives an input signal from its own IR remote control. Therefore, the input data adaptation layer in front of the input data transmission routine converts transmitted data to a corresponding IR remote control's input signal, and resends the signal to the input data transmission routine as if the WLAN remote control data were the input signal from a corresponding appliance's IR remote control.

This input data adaptation layer plays a key role in the transmission of a WLAN signal as the remote control input signal, while keeping the old construction of the appliance. Thus, input data adaptation layer can be one small data transmission application existing in the WLAN module.

Therefore, pressing a button 1 (e.g. data value: 0x59) on the WLAN terminal in remote control mode yields the same result as pressing button 1 (e.g. data value: 0x97100059) on a general IR remote control of the appliance.

In conclusion, the wireless terminal can be used in place of the remote control for controlling appliances at the remote place. Unlike using infrared remote controls to control the plurality of appliances, one 802.11x wireless terminal can now control the plurality of appliances.

Any one who has a mobile phone, a smart phone, a PDA, a VoIP terminal or any other wireless terminal can easily control a plurality of appliances.

In particular, a terminal like a PDA with a special image display device can be provided with a UI that has the exact same configuration as that of a remote control. Thus, the user will feel like he is using a remote control instead of a wireless terminal. On the other hand, each of the general mobile phones with a display only has a special mark indicating a remote control function. Either way, users are able to control appliances very conveniently.

While the present invention has been particularly shown and described with reference to exemplary embodiments thereof, it will be understood by those skilled in the art that the foregoing and other changes in form and details can be made therein without departing from the spirit and scope of the present invention.

What is claimed is:

1. A method of remote controlling a plurality of appliances, the method comprising:
receiving appliance remote control data transmitted from a wireless terminal via a network;
determining if remote control mode data is included in the received remote control data;
determining if data associated with a kind of appliance to be controlled is identical with data associated with a kind of appliance listed in a predetermined appliance table if it has been determined that remote control data is included in the received remote control data; and
transmitting the appliance remote control data provided from the wireless terminal to a corresponding appliance via the network if it has been determined that the data associated with the kind of appliance to be controlled is identical with the data associated with the kind of appliance listed in the predetermined appliance table.

2. The method according to claim 1, wherein the appliance remote control data being transmitted to the corresponding appliance comprises an IP address of the corresponding appliance.

3. The method according to claim 1, further comprising:
transmitting an error message to the wireless terminal via the network if the data associated with the kind of appliance to be controlled is not listed in the predetermined appliance table.

4. The method according to claim 1, wherein the network comprises a WLAN (Wireless Local Area Network).

5. A method of remote controlling an appliance, the method:
receiving appliance remote control data from an AP (Access Point), the data being transmitted from a wireless terminal to the AP via a WLAN (Wireless Local Area Network);
converting a corresponding appliance's function control data from the received appliance remote control data to data recognizable by the corresponding appliance; and
controlling a function of the corresponding appliance using the converted data.

6. The method according to claim 5, wherein the appliance remote control data received through the AP comprises an IP address of the appliance, a remote control mode code, an appliance code, and an appliance's function control code.

7. The method according to claim 5, wherein the data recognizable by the corresponding appliance is IR data used by the corresponding appliance.

8. The method according to claim 5, wherein converting the appliance's function control data to data recognizable by the corresponding appliance comprises:
distinguishing a kind of data by analyzing the received remote control mode code, and determining if the received data is appliance remote control data or general WLAN remote control data; and
converting the appliance's function control code to an IR data used by the corresponding appliance if the received data is WLAN remote control data.

9. The method according to claim 6, wherein converting the appliance's function control data to data recognizable by the corresponding appliance comprises:
distinguishing a kind of data by analyzing the received remote control mode code, and determining if the received data is appliance remote control data or general WLAN remote control data; and
converting the appliance's function control code to an IR data used by the corresponding appliance if the received data is WLAN remote control data.

10. A method of remote controlling an appliance, the method comprising:
setting a wireless terminal in a remote control mode, selecting an appliance to be controlled out of a plurality of appliances and selecting a corresponding function of the appliance, and transmitting appliance remote control data from a wireless terminal to an AP (Access Point) via a WLAN (Wireless Local Area Network) to remote control the appliance;
transmitting the appliance remote control data from the wireless terminal to the corresponding appliance via the WLAN if data associated with a kind of appliance included in appliance remote control data provided from the wireless terminal via the WLAN is determined to be appliance data listed in a predetermined appliance table, the determination being made in the AP; and
the corresponding appliance converting the appliance remote control data provided from the AP to data recognizable by the corresponding appliance, and controlling a function of the appliance using the converted data.

11. The method according to claim 10, wherein transmitting the appliance remote control data to the AP via the WLAN comprises:
setting the appliance in a remote control mode for remote controlling;
selecting an appliance to control from among a plurality of appliances;
displaying a remote control image of the selected appliance;
selecting a corresponding function of the appliance to control through the displayed remote control image of the corresponding appliance; and
creating a code for the predetermined remote control mode, a code for the selected appliance, and a function control code of a corresponding appliance, and formatting each of the codes into a network transmission format.

12. The method according to claim 10, wherein the wireless terminal comprises at least one of a terminal having an 802.11x wireless servicing capacity, a PDA, a smart phone, and a wireless VoIP phone.

13. The method according to claim 10, wherein transmitting the appliance remote control data to the corresponding appliance via the WLAN comprises:
receiving the appliance remote control data transmitted from the wireless terminal via the WLAN;
determining if remote control mode data is included in the received appliance remote control data;
determining if data associated with a kind of appliance to be controlled is identical with data associated with a kind of appliance listed in a predetermined appliance table if it has been determined that the remote control mode data is included in the received appliance remote control data; and
transmitting the appliance remote control data provided from the wireless terminal to a corresponding appliance via the network only if the data associated with the kind of appliance to be controlled is identical with the data associated with the kind of appliance listed in the predetermined appliance table.

14. The method according to claim 10, wherein controlling the appliance's function comprises:
receiving the appliance remote control data transmitted from the AP over the WLAN;
converting the corresponding appliance's function control data from among the received appliance remote control data to IR data recognizable by the corresponidng appliance; and
controlling a function of the corresponding appliance using the converted IR data.

15. The method according to claim 14, wherein converting the received data to the IR data recognizable by the corresponding appliance comprises:
distinguishing a kind of data by analyzing the received remote control mode code, and determining if the received data is appliance remote control data or general WLAN remote control data; and
converting the appliance's function control code to IR data used by the corresponding appliance if the received data is determined to be WLAN remote control data.

16. An appliance remote control system, comprising:
a wireless terminal adapted to transmit appliance remote control data over a WLAN (Wireless Local Area Network) by setting a corresponding mode of the wireless terminal to a remote control mode to remotely control an appliance and to select a kind of appliance to control from among a plurality of appliances and a function of the appliance to be controlled;
an AP (Access Point) adapted to transmit appliance remote control data provided from the wirelss terminal to the corresponding selected appliance, if data associated with a kind of appliance included in the appliance remote control data transmitted from the wireless terminal via the WLAN is identical to appliance data listed in a predetermined appliance table; and
an appliance controller arranged within the appliance and adapted to convert an appliance's function control data included in the appliance remote control data transmitted from the AP to data recognizable by the corresponding appliance, and to control a function of the corresponding appliance utilizing the converted data.

17. The system according to claim 16, wherein the wireless terminal comprises at least one of a terminal having an 802.11x wireless servicing capacity, a PDA, a smart phone, and a wireless VoIP phone.

18. The system according to claim 16, wherein the wireless terminal comprises:
a key input unit adapted to enable a user to set a remote control mode to remotely control the appliances, and to select an appliance to control out of the plurality of appliances and to select a corresponding function of the appliance to control;
a user interface (UI) adapted to display a remote control image for the selected appliance on a display device, if the appliance to be controlled has been selected by the user using the key input unit; and
a transmitter adapted to transmit data comprising a code for the remote control mode, a code for the selected appliance, and a control code of the corresponding appliance's function in an appliance remote control data form to the AP via the WLAN, the data being formatted specifically for the WLAN transmission.

19. The system according to claim 18, wherein the appliance remote control data comprises at least one of a header, a remote control mode code, an appliance code, and an appliance's function control code.

20. The system according to claim 16, wherein the AP comprises:
a receiver adapted to receive the appliance remote control data transmitted from the wireless terminal via the WLAN network;
a comparison/decision unit for determining if remote control mode data is included in the received remote control data, and if the remote control mode data exists, determining if data associated with a kind of appliance to be controlled is identical with data associated with a kind of appliance listed in a predetermined appliance table; and
a transmitter adapted to transmit the appliance remote control data from the wireless terminal to the corresponding appliance over the WLAN network, if the data associated with the kind of appliance to be controlled is identical with the data associated with the kind of appliance listed in the predetermined appliance table.

21. The system according to claim 20, wherein the appliance remote control data to be transmitted to the corresponding appliance comprises an IP address of the corresponding appliance.

22. The system according to claim 20, wherein the transmitter sends an error message to the wireless terminal via the WLAN network if the data associated with the kind of corresponding appliance does not exist in the appliance table.

23. The system according to claim 16, wherein the appliance controller comprises:
a WLAN data receiver adapted to receive appliance remote control data transmitted from the AP via the WLAN network;
a WLAN data analyzer adapted to analyze a remote control mode code included in the appliance remote control data being received through the WLAN data receiver, to determine if the data is appliance remote control data or general WLAN data;
a data converter adapted to convert the control code of the appliance's function into data recognizable by the corresponding appliance if the data being analyzed by the WLAN analyzer is the WLAN remote control data; and
a controller adapted to control a function of the corresponding appliance using the converted data from the data converter.

24. The system according to claim 23, wherein the appliance remote control data received from the WLAN data receiver is in a format comprising at least one of an IP address of an appliance, a remote control mode code, an appliance code, and a control code of the appliance's function.

25. The system according to claim 16, wherein the data recognizable by the corresponding appliance comprises IR data used in the corresponding data.
